(19) United States
(12) Patent Application Publication
(10) Pub. No.: US 2025/0190715 A1
(43) Pub. Date: Jun. 12, 2025

(54) INFORMATION PROCESSING APPARATUS, INFORMATION PROCESSING METHOD, AND RECORDING MEDIUM

(71) Applicant: NEC Corporation, Tokyo (JP)

(72) Inventors: Yoshio KAMEDA, Tokyo (JP); Keita SAKUMA, Tokyo (JP); Ryuta MATSUNO, Tokyo (JP); Masakazu HIROKAWA, Tokyo (JP)

(73) Assignee: NEC Corporation, Tokyo (JP)

(21) Appl. No.: 18/931,199

(22) Filed: Oct. 30, 2024

(30) Foreign Application Priority Data
Dec. 12, 2023 (JP) 2023-209024

(51) Int. Cl. G06F 40/40

(52) U.S. Cl. CPC G06F 40/40

(57) ABSTRACT

An information processing device acquires a prompt input by a user, acquires an analytical algorithm designated in the prompt, and outputs a question based on the analytical algorithm, executes the analytical algorithm interactively by acquiring an answer of the user to the question, and outputs an analysis result.

### TECHNICAL FIELD

The present disclosure relates to analysis of a machine learning model.

### BACKGROUND ART

MLOps (Machine Learning Operations) is recognized as a technology that enables the continuous and cost-effective operation of machine learning models. MLOps encompasses techniques for developing, deploying, and managing a machine learning model. Particularly, in a practical operation of a system using the machine learning model, it is important to analyze a factor contributing to a decrease in prediction accuracy of the machine learning model.

In order to analyze the factor contributing to the decrease in prediction accuracy in an operational system, sufficient knowledge and experience in programming during a development of the machine learning model and maintenance during the operation are required. Additionally, Patent Document 1 discloses a method for converting natural language into a programming language.
Patent Document 1: Japanese Laid-open Patent Publication No. 2002-182913

### SUMMARY

It is one object of the present disclosure to enable appropriate analysis of a factor contributing to a decrease in prediction accuracy caused by a machine learning model, even in a case where knowledge and experience related to a development and an operation of a machine learning model are not necessarily sufficient.

According to an example aspect of the present disclosure, there is provided an information processing device including:
at least one memory configured to store instructions; and
at least one processor configured to execute the instructions to:
acquire a prompt input by a user;
acquire an analytical algorithm designated in the prompt; and
output a question based on the analytical algorithm, execute the analytical algorithm interactively by acquiring an answer of the user to the question, and output an analysis result.

According to another example aspect of the present disclosure, there is provided an information processing method performed by a computer, the information processing method including:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.

According to a further example aspect of the present disclosure, there is provided a program causing a computer to perform a process including:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.

According to the present disclosure, it is possible for even a person who does not necessarily have sufficient knowledge or experience in a development and an operation of a machine learning model to appropriately analyze the factor contributing to the decrease in prediction accuracy of the machine learning model.

### BRIEF DESCRIPTION OF THE DRAWINGS

FIG. 1 illustrates an overall configuration of an analysis system to which an information processing device according to the present disclosure is applied.

FIG. 2 is a block diagram illustrating a hardware configuration of the information processing device 10.

FIG. 3 is a block diagram illustrating a hardware configuration of a terminal device.

FIG. 4 is a block diagram illustrating a functional configuration of the information processing device.

FIG. 5 is an example of a flowchart illustrating an example of an analytical algorithm.

FIG. 6 illustrates an example of the analytical algorithm described in natural language.

FIG. 7 illustrates examples of a prompt input by a user and a message output from the information processing device.

FIG. 8 is a flowchart of an analysis process.

FIG. 9 is a block diagram illustrating a functional configuration of an information processing device according to a second example embodiment.

FIG. 10 is a flowchart of a process performed by the information processing device according to the second example embodiment.

### EXAMPLE EMBODIMENTS

In the following, example embodiments will be described with reference to the accompanying drawings.

### First Example Embodiment

### [Overall Configuration]

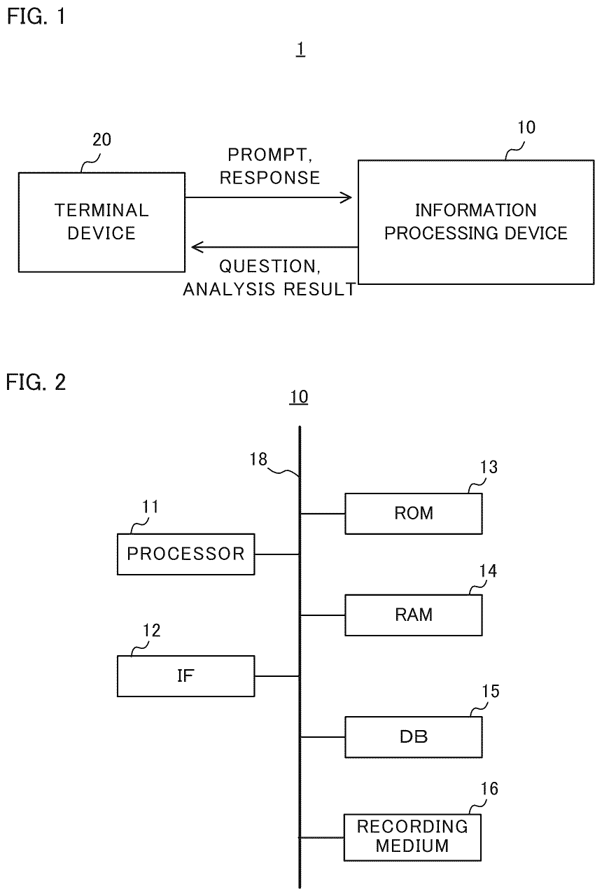

FIG. 1 illustrates an overall configuration of an analysis system to which an information processing device according to the present disclosure is applied. The analysis system 1 analyzes a factor if a decrease in prediction accuracy (hereinafter, referred to as a “prediction error”) occurs during an operation of a prediction process using a machine learning model. As illustrated, the analysis system 1 includes an information processing device 10, and a terminal device 20. The information processing device 10 and the terminal device 20 can communicate via wire or wireless connections.

The terminal device 20 is operated by a user who manages and maintains the machine learning model (hereinafter, referred to as a “predictive model”) for performing a predetermined prediction. The predetermined prediction may be a variety of predictions, for instance, forecasts of weather, forecasts of power demand, forecasts of sales at stores, and the like. In the present example embodiment, the user may need a certain level of knowledge and experience in the development and maintenance of machine learning model, but the user does not need to be an expert with extensive knowledge and experience.

If the prediction error occurs in the predictive model in operation, the user analyzes the factor of the prediction error. Specifically, if the prediction error occurs, the user operates the terminal device 20, and transmits a prompt instructing a factor analysis of the prediction error to the information processing device 10.

The information processing device 10 interprets the input prompt using a natural language model and executes analysis of a factor of a prediction error. Note that the “prompt” refers to an instruction sentence to a generation AI (Artificial Intelligence) including a natural linguistic model, or the like. The information processing device 10 interactively executes the factor analysis of the prediction error using an analytical algorithm prepared in advance. Specifically, according to the analytical algorithm, the information processing device 10 asks the user regarding variables or the predictive model, and acquires an answer of the user. Then, the information processing device 10 analyzes the factors of the prediction error based on the answer of the user, and generates an analysis result to output to the terminal device 20. Accordingly, the user can analyze the factor of the prediction error by inputting natural language into the information processing device 10.

### [Natural Language Model]

Here, the natural language model will be described. The natural language model is a model which learns the relationships between words in a sentence, and generates relevant strings which is related to a target string, based on the target string. By using the natural language model which learns sentences and phrases of various contexts, it is possible to generate a relevant string of reasonable description related to the target string. For instance, a case of using the natural language model in question and answer will be described below. In this case, the natural language model accepts a question “What kind of country is Japan?” as the target string, and generates a string such as “Japan is an island in the northern hemisphere . . . ”, as the answer to the question.

The learning method of the natural language model is not particularly limited, but may be one which is learned to output at least one sentence including an input string as an example. For instance, the natural language model may be a GPT (Generative Pre-Training of outputting a sentence containing the input string by predicting a most probable string following the input string. Alternatively, the natural language model may be, for instance, T5 (Text-to-Text Transfer Transformer), BERT (Bidirectional Encoder Representations from Transformers), ROBERTa (Robustly optimized BERT approach), ELECTRA (Efficiently Learning an Encoder that Classifies Token Replacements Accurately), or the like. In the present example embodiment, a large-scale language model may be used as the natural language model. The natural language model may also be capable of accessing the Internet or other specialized knowledge bases to obtain information.

### [Hardware Configuration]

### (Information Processing Device)

FIG. 2 is a block diagram illustrating a hardware configuration of the information processing device 10. As illustrated, the information processing device 10 includes a processor 11, an interface (IF) 12, a ROM (Read Only Memory) 13, a RAM (Random Access Memory) 14, a database (DB) 15, and a recording medium 16. These components are mutually connected, for instance, via a bus 18.

The processor 11 is a computer such as a CPU (Central Processing Unit) and controls the entire information processing device 10 by executing a program prepared in advance. Specifically, the processor 11 may be a CPU, a GPU (Graphics Processing Unit), a DSP (Digital Signal Processor), a MPU (Micro Processing Unit), a FPU (Floating Point number Processing Unit), a PPU (Physics Processing Unit), a TPU (Tensor Processing Unit), a quantum processor, a microcontroller, or a combination thereof.

The processor 11 loads the program stored in the ROM 13 or the recording medium 16 to the RAM 14, and executes processes coded in the program. The processor 11 functions as part or all of the information processing device 10. The processor 11 performs a factor analysis process which will be described later.

The IF 12 transmits and receives data to and from an external device. Specifically, the information processing device 10 receives, through the IF 12, a prompt which instructs the factor analysis or a response to a question output to the user from the terminal device 20.

The ROM 13 stores various programs to be executed by the processor 11. The RAM 14 is used as a working memory during executions of various processes by the processor 11.

The DB 15 stores a plurality of analytical algorithms used for factorial analysis.

The recording medium 16 is a non-volatile and non-transitory recording medium such as a disk-shaped recording medium or a semiconductor memory. The recording medium 16 may be detachably formed to the information processing device 10. The recording medium 16 records various programs executed by the processor 11.

In addition to the above, the information processing device 10 may include a display device such as a liquid crystal display or the like, and an input device such as a keyboard, a mouse, or the like. These display devices and the input device, for instance, is used by an administrator of the information processing device 10.

### (Terminal Equipment)

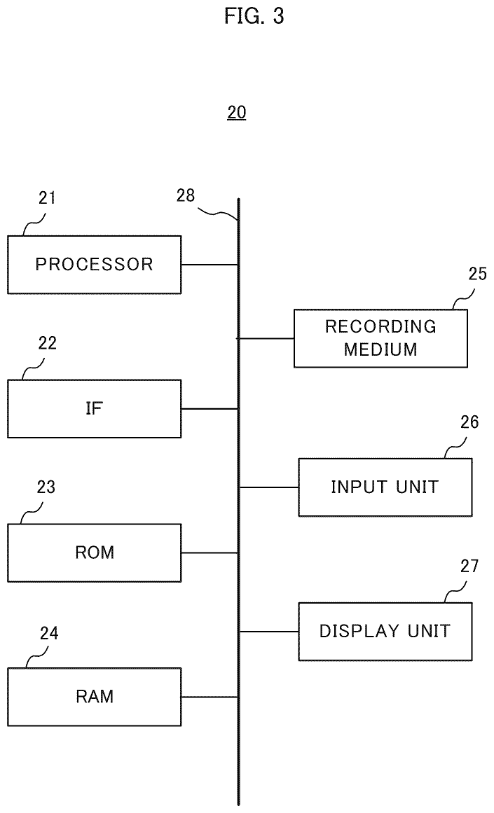

FIG. 3 is a block diagram illustrating a hardware configuration of the terminal device 20. The terminal device 20 is, for instance, a PC or a tablet terminal. As illustrated, the terminal device 20 includes a processor 21, an IF 22, a ROM 23, a RAM 24, an input unit 26, and a display unit 27. Each component is connected, for instance, through a bus 28.

The processor 21 is a computer such as a CPU, and controls the entire terminal device 20 by executing programs prepared in advance. The processor 21 may be a GPU, an FPGA, a DSP, an ASIC or the like.

The IF 22 transmits and receives data to and from an external device. Specifically, the terminal device 20 transmits the prompt created by the user and the answer of the user to the question to the information processing device 10 through the IF 22. The terminal device 20 receives the question to the user and the analysis result from the information processing device 10 through the IF 22.

The ROM 23 stores various programs executed by the processor 21. Also, the RAM 24 is used as a working memory during executions of various operations by the processor 21.

The recording medium 25 is a non-volatile and non-temporary recording medium such as a disk-shaped recording medium or a semiconductor memory. The recording medium 25 may be detachably formed to the terminal device 20. The recording medium 25 records various programs executed by the processor 21.

The input unit 26 is, for instance, an input device such as a keyboard, a mouse, or a touch panel. The display unit 27 is a display for displaying data based on a control of the processor 21.

### [Function Configuration]

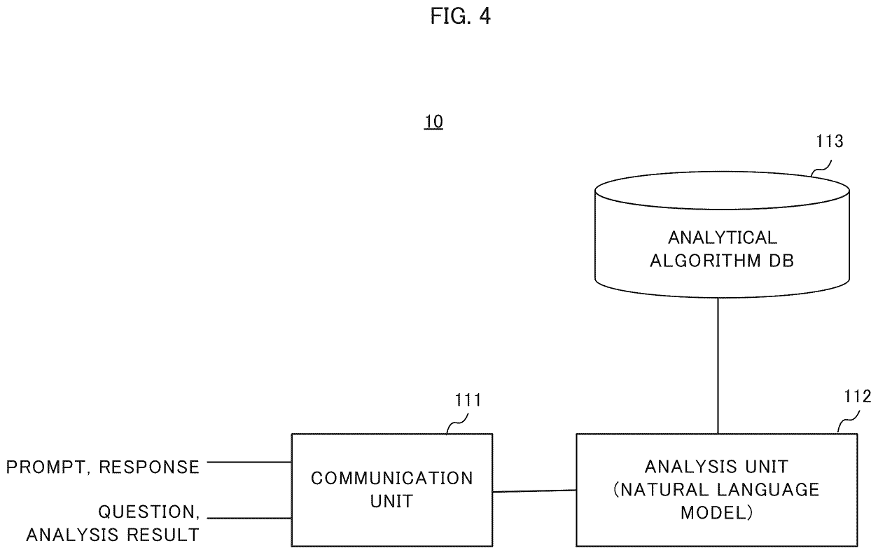

FIG. 4 is a block diagram illustrating a functional configuration of the information processing device 10 according to the first example embodiment. The information processing device 10 functionally includes a communication unit 111, an analysis unit 112, and an analytical algorithm DB 113.

The communication unit 111 is formed by the IF 12 illustrated in FIG. 2, and receives the prompt and the answer to the question from the terminal device 20, and transmits the question and the analysis result to the terminal device 20. The communication unit 111 outputs the prompt and the answer which are received from the terminal device 20 to the analysis unit 112.

The analytical algorithm DB 113 is formed by the DB 15 illustrated in FIG. 2, and stores a plurality of analytical algorithms prepared in advance. Each analytical algorithm is designed to analyze the factor of the prediction error which have occurred in the predictive model during an operation, and is provided, for instance, for each predictive model. Several analytical algorithms may be provided to perform analyses from different points of view for the same predictive model. Each analytical algorithm is described in natural language, although details will be described later.

The analysis unit 112 is formed by the processor 11 illustrated in FIG. 2, to analyze the factor of the prediction error using the analytical algorithm. The analysis unit 112 is formed using the natural language model which can interpret the prompt described in natural language.

At the time of the factor analysis of the prediction error, the analysis unit 112 acquires a prompt which the user has created by operating the terminal device 20. The prompt includes information designating the analytical algorithm to be used for the analysis and an instruction to perform the factor analysis of the prediction error, as will be described in detail below. The analysis unit 112 acquires an analytical algorithm designated from the analytical algorithm DB 113 in accordance with the prompt. The analytical algorithm is described in natural language, and the analysis unit 112 interprets and executes the analytical algorithm using the natural language model.

During the execution of the analytical algorithm, the analysis unit 112 performs the necessary question to the user. Specifically, the analysis unit 112 generates the question corresponding to a conditional branch included in the analytical algorithm, and transmits the question to the terminal device 20 via the communication unit 111. The user operates the terminal device 20 to send the answer for the question, and the analysis unit 112 acquires the answer through the communication unit 111. Then, the analysis unit 112 makes a determination for the conditional branch based on the acquired answer and continues an execution of the analytical algorithm. Thus, the analysis unit 112 repeats transmitting of the question to the user and acquiring of the answer for each conditional branch included in the analytical algorithm, and executes the analytical algorithm interactively. Then, if the analysis result is acquired in accordance with the analytical algorithm, the analysis unit 112 transmits the analysis result to the terminal device 20. Note that the analysis unit 112 corresponds to examples of a prompt acquisition unit, an algorithm acquisition unit, and an analysis execution unit.

As described above, in the present example embodiment, the information processing device 10 executes the analysis process interactively by repeating questions and answers in natural language in accordance with the analytical algorithm prepared in advance. Therefore, it is possible for the user who analyzes the prediction error to proceed with the analysis along the analytical algorithm only by answering the questions transmitted from the information processing device 10. Therefore, if an appropriate analytical algorithm is prepared, it is possible even for the user who does not have advanced knowledge and experience related to analysis of the prediction errors to perform the appropriate analysis.

### Analysis Example

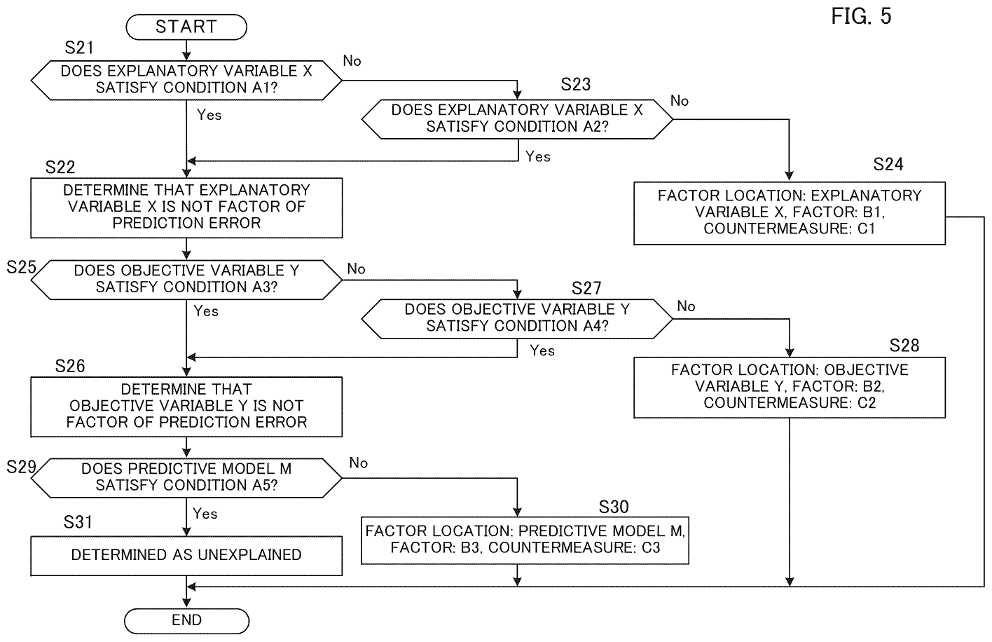

Next, an example of the factor analysis of the prediction error by the analysis unit 112. FIG. 5 is a flowchart illustrating an example of the analytical algorithm (hereinafter, referred to as “analytical algorithm AG”). In this example, the analytical algorithm AG analyzes the factor of the prediction error (hereinafter referred to as “prediction error factor”) from a viewpoint of whether the prediction error factor is the explanatory variable X, the objective variable Y, and a predictive model M itself used by the predictive model M. Then, the analytical algorithm AG outputs, as the analysis result, a location where the prediction error factor exists (hereinafter, referred to as a “factor location”), the factor, and the countermeasure.

First, the analytical algorithm AG analyzes whether or not the explanatory variable X is the prediction error factor. Specifically, if the explanatory variable X satisfies a condition A1 (step S21: Yes), the analytical algorithm AG determines that the explanatory variable X is not the prediction error factor (step S22). Moreover, if the explanatory variable X does not satisfy the condition A1 but satisfies a condition A2 (step S23: Yes), the analytical algorithm AG determines that the explanatory variable X is not the prediction error factor (step S22). On the other hand, if the explanatory variable X does not satisfy both the condition A1 and the condition A2 (step S23: No), the analytical algorithm AG determines that the explanatory variable X is the prediction error factor and outputs the analytical result “Factor location: Explanatory variable X, Factor: B1, Countermeasure: C1” (step S24).

If the explanatory variable X is not the prediction error factor, the analytical algorithm AG analyzes whether or not the objective variable Y is the prediction error factor. Specifically, if the objective variable Y satisfies a condition A3 (step S25: Yes), the analytical algorithm AG determines that the objective variable Y is not the prediction error factor (step S26). Moreover, if the objective variable Y does not satisfy the condition A3 but satisfies a condition A4 (step S27: Yes), the analytical algorithm AG determines that the objective variable Y is not the prediction error factor (step S26). On the other hand, if the objective variable Y does not satisfy both the condition A3 and the condition A4 (step S27: No), the analytical algorithm AG determines that the objective variable Y is the prediction error factor and outputs the analysis result “Factor location: Objective variable Y, Factor: B2, Countermeasure: C2” (step S28).

If the objective variable Y is not a factor, the analytical algorithm AG analyzes whether or not the predictive model M is the prediction error factor. Specifically, the analytical algorithm AG determines that the predictive model M is the prediction error factor if the predictive model M does not satisfy the condition A5 (step S29: No), and outputs the analysis result “Factor location: Model M, Factor: B3, Countermeasure: C3” (step S30). On the other hand, if the predictive model M satisfies the condition A5 (step S29: Yes), the analytical algorithm AG determines that the prediction error is an unexplained factor, and outputs the analysis result of “unexplained factor” (step S31).

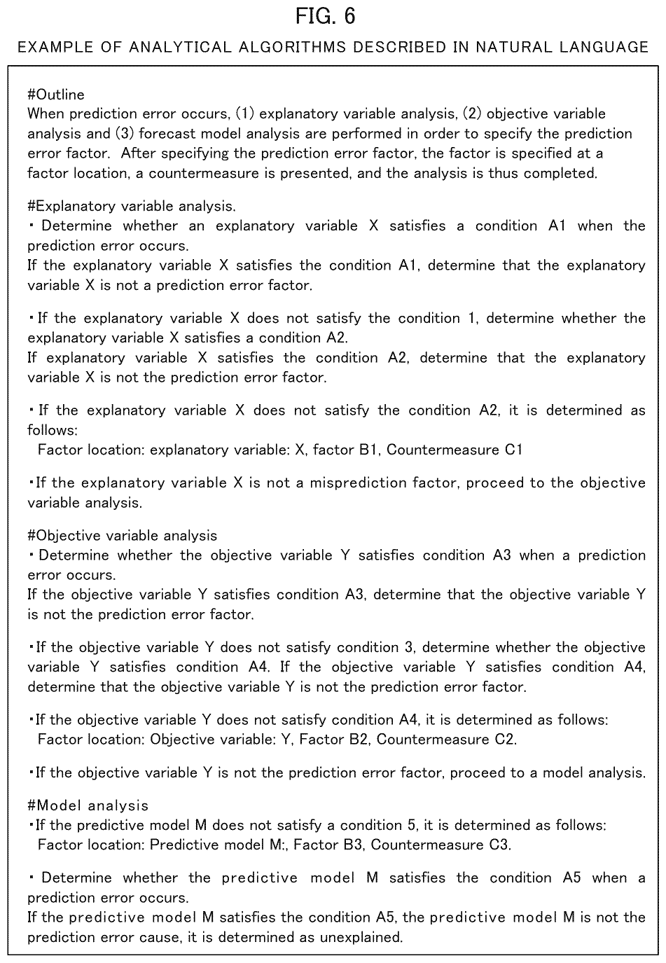

Note that for convenience of explanation, details of the analytical algorithm AG have been described in the flowchart in FIG. 5, but in practice, the analytical algorithm AG may be described in a programing language, may be described in IF-THEN rules, or may be described in other forms. Next, based on the analytical algorithm AG described in one of the above forms, the analytical algorithm AG described in natural language is generated and stored in the analytical algorithm DB 113. FIG. 6 illustrates an example of the analytical algorithm AG described in natural language.

In FIG. 6, an item “#Outline” describes that the analytical algorithm AG performs the factor analysis of the prediction error in order of the explanatory variable, the objective variable, and the predictive model, and outputs the factor location, the factor, and the countermeasure as analysis result.

An item “#Explanatory variable analysis” describes contents of steps S21 to S24 in FIG. 5 as an analysis of the explanatory variable. An item “#Objective variable analysis” describes contents of steps S25 to S28 in FIG. 5 as an analysis of the objective variable. In addition, an item “#Model analysis” describes contents of steps S29 to S31 in FIG. 5 as an analysis of the predictive model.

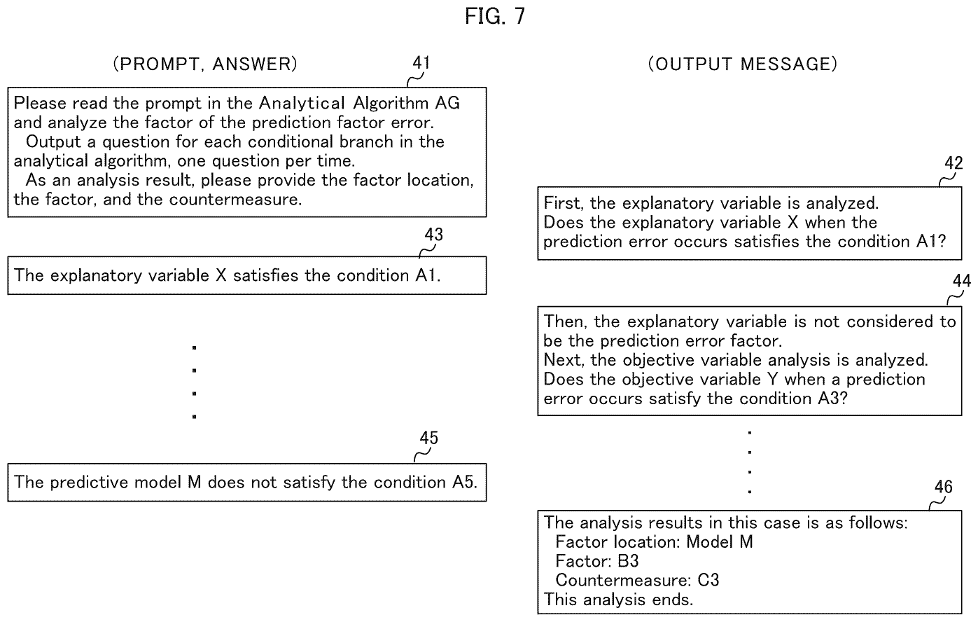

The user generates a prompt including a designation of the analytical algorithm AG and an instruction to perform the factor analysis, and inputs the prompt to the information processing device 10. FIG. 7 illustrates an example of the prompt input by the user and a message output by the information processing device 10. First, a prompt 41 created by the user is input to the information processing device 10. The prompt 41 includes the designation of the analytical algorithm AG to be used in the analysis and the instruction to perform the factor analysis of the prediction error. Also, the prompt 41 instructs to output one question for each conditional branch of the analytical algorithm AG, and to output the factor location, the factor, and the countermeasure as the analysis result.

The analysis unit 112 of the information processing device 10 interprets the prompt 41 using the natural language model and acquires the analytical algorithm AG designated from the analytical algorithm DB 113. The analytical algorithm AG is described in natural language as illustrated in FIG. 6, and the analysis unit 112 interprets the analytical algorithm AG using the natural language model and executes the analytical algorithm AG. Thus, the analysis unit 112 executes the analysis in a procedure of the analytical algorithm illustrated in FIG. 5.

Specifically, the analysis unit 112 generates a question 42 asking whether or not the explanatory variable X satisfies the condition A1 based on a conditional branch of step S21 in FIG. 5 and transmits the generated question 42 to the terminal device 20. The user sends an answer (prompt) 43 to the information processing device 10. Next, the analysis unit 112 determines that the explanatory variable X is not the prediction error factor as illustrated in step S22 based on the answer 43. Next, the analysis unit 112 generates a question 44 asking whether or not the objective variable Y satisfies the condition A3 based on a conditional branch of step S25, and transmits the generated question 44 to the terminal device 20.

That is, the analysis unit 112 provides the question 44 to the user according to the analytical algorithm AG, and proceeds the analysis based on an answer 45 to the question 44. If the answer 45 to the question based on the conditional branch of the step S29 is received, the analysis unit 112 outputs an analysis result 46 according to step S30 and terminates the analysis.

As described above, in the present example embodiment, the user interacts with the information processing device 10 using natural language, so that the factor analysis of the prediction error can be performed. Therefore, it is possible for even the user who does not have advanced knowledge or experience concerning the machine learning model to appropriately perform factor analysis.

### [Analysis Process]

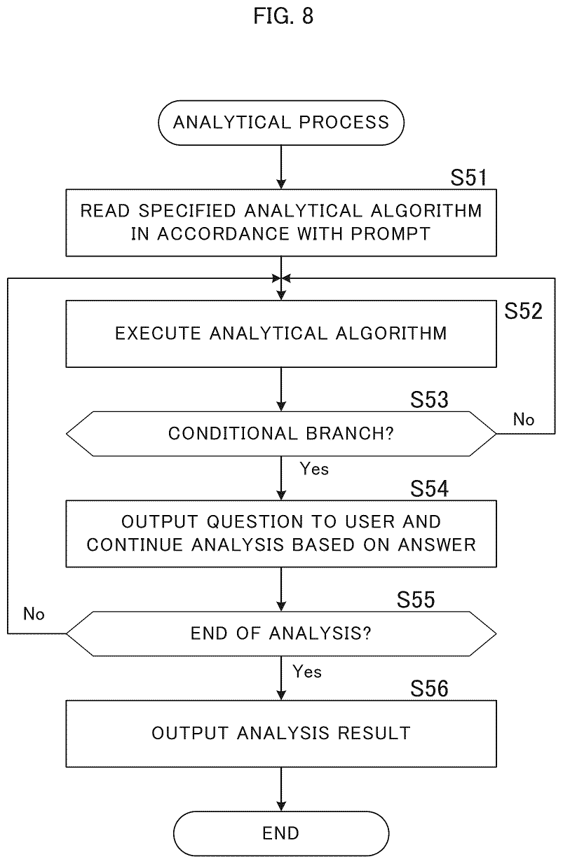

Next, a flow of the analysis process for performing the analysis as described above will be described. FIG. 8 is a flowchart of the analysis process. This analysis process is realized by the processor 11 illustrated in FIG. 2 executing a program prepared in advance and operating as a corresponding element illustrated in FIG. 4.

First, the information processing device 10 reads the designated analytical algorithm from the analytical algorithm DB 113 in accordance with the prompt generated by the user (step S51). Next, the information processing device 10 executes the designated analytical algorithm (step S52). If there is a conditional branch in the analytical algorithm (step S53: Yes), the information processing device 10 generates a question corresponding to that condition, transmits the generated question to the terminal device 20, and continues the analysis based on an answer of the user to the question (step S54). Thus, the information processing device 10 performs the question to the user for each conditional branch and continues the analysis. Next, if the information processing device 10 ends the analysis in accordance with the analytical algorithm (step S55: Yes), the information processing device 10 outputs the analysis result to the terminal device 20 (step S56). After that, the analysis process is terminated.

### [Modifications]

Next, modifications of the above example embodiment will be described. The following modification can be applied in appropriate combination.

### (Modification 1)

In the above-described analysis example, the analysis unit 112 asks the user concerning all conditional branches in the analytical algorithm, but if information on a specific conditional branch has been already acquired, the question concerning the specific conditional branch can be omitted. For instance, if the prompt created by the user at a start of the analysis includes a statement that “the explanatory variable X satisfies the conditions A1 and A2,” the analysis unit 112 may omit questions corresponding to steps S21 and S23 in FIG. 5 and perform a question corresponding to step S25. Similarly, even if the statement indicating that “the explanatory variable X is not the factor of a prediction error” is included in the prompt created by the user at the start of the analysis, the analysis unit 112 may omit the questions corresponding to steps S21 and S23 in FIG. 5 and perform the question corresponding to step S25.

Moreover, if the user executes the analysis again by changing the answer to the question or the like, the analysis unit 112 can omit the question for a part which uses a previous answer of the user. For instance, in a case where the prompt created by the user at the start of the analysis includes a statement that “the answer to the explanatory variable X is assumed as the same as the previous analysis and execute the analysis again”, the analysis unit 112 may perform the analysis by diverting the previous answer of the user for steps S21 and S23 in FIG. 5.

### (Modification 2)

The analysis unit 112 may change wording of the question depending on a level of knowledge or experience of the user (hereinafter, simply referred to as “knowledge level”). For instance, the analysis unit 112 may change terms and phrases used for questions depending on a data scientist having an experience of less than three years and a data scientist having an experience of three years or more. In a case where the knowledge level of the user is low, the analysis unit 112 may generate a question by reducing the use of technical terms in the questions to the user, using a less technical term if there are multiple terms with the same meaning, adding explanations of the technical terms, and the like.

In this case, if the information processing device 10 has information on the knowledge level of the user, the wording of the question may be changed based on that information. Also, if the user specifies the knowledge level of the user at the prompt, the wording of the question may be changed accordingly. For instance, if the user describes “ask a question at the knowledge level of the data scientist having the experience of less than three years” at the prompt, the information processing device 10 may generate the question adjusted to the knowledge level.

In addition, if the user answers to the question output by the information processing device 10 such as “I don't understand the meaning of the question.” or “I don't understand the meaning of the term XX in the question.”, the information processing device 10 may regenerate the question with a different expression or re-generate the question using different term.

### (Modification 3)

In the analysis example described above, the information processing device 10 outputs the question to the user corresponding to the conditional branch in the analytical algorithm, but the question to the user is not limited to that related to the conditional branch. For instance, it may be a question to confirm a type of the analytical algorithm, a precondition if executing the analytical algorithm, or the like.

### (Modification 4)

In the example embodiment described above, the user designates the analytical algorithm in the prompt, and the information processing device 10 acquires the designated analytical algorithm from the analytical algorithm DB 113. Alternatively, the user may make an analysis instruction to the information processing device 10 by including the analytical algorithm described in natural language in the prompt. For instance, the use may instruct to use the analytical algorithm in the prompt by including a description of the analytical algorithm illustrated in FIG. 6 at an end of the prompt 41 illustrated in FIG. 7, and including a first sentence of “Analyze the prediction error factor using the analytical algorithm described below.” in the prompt 41, and the like.

### (Modification 5)

In the example embodiment described above, the analytical algorithm described in natural language is stored in the analytical algorithm DB 113 illustrated in FIG. 4, and the analysis unit 112 interprets and executes the analytical algorithm using the language model. Alternatively, in a case where the analysis unit 112 includes the language model capable of interpreting not only natural language but also the programing language, the analytical algorithm described in the programing language may be stored in the analytical algorithm DB 113, and the analysis unit 112 may interpret and execute the analytical algorithm.

### Second Example Embodiment

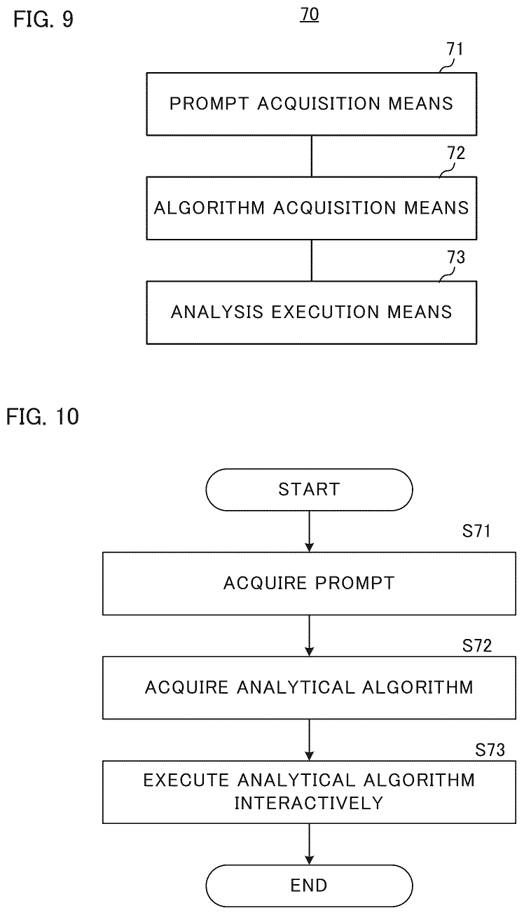

FIG. 9 is a block diagram illustrating a functional configuration of an information processing device according to a second example embodiment. An information processing device 70 includes a prompt acquisition means 71, an algorithm acquisition means 72, and an analysis execution means 73.

FIG. 10 is a flowchart of a process performed by the information processing device according to the second example embodiment. The prompt acquisition means 71 acquires the prompt input by the user (step S71). The algorithm acquisition means 72 acquires the analytical algorithm designated in the prompt (step S72). The analysis execution means 73 interactively executes the analytical algorithm by outputting a question based on the analytical algorithm and acquiring an answer of the user with respect to the question, and outputs the analysis result (step S73).

According to the information processing device 70 of the second example embodiment, it is possible for even a person who does not necessarily have sufficient knowledge or experience in a development and an operation of a machine learning model to appropriately analyze the factor contributing to the decrease in prediction accuracy of the machine learning model.

A part or all of the example embodiments described above may also be described as the following supplementary notes, but not limited thereto.

### (Supplementary Note 1)

An information processing device comprising:
a prompt acquisition means configured to acquire a prompt input by a user;
an algorithm acquisition means configured to acquire an analytical algorithm designated in the prompt; and
an analysis execution means configured to output a question based on the analytical algorithm, execute the analytical algorithm interactively by acquiring an answer of the user to the question, and output an analysis result.

### (Supplementary Note 2)

The information processing device according to supplementary note 1, wherein
the analytical algorithm is described in natural language, and
the analysis execution means outputs the question using a language model, and also executes the analytical algorithm by interpreting the analytical algorithm using the language model.

### (Supplementary Note 3)

The information processing device according to supplementary note 1, wherein the analysis execution means outputs the question concerning each of conditional branches included in the analytical algorithm.

### (Supplementary Note 4)

The information processing device according to supplementary note 3, wherein
the prompt includes first information related to the one or more conditional branches, the first information indicating whether or not one or more conditions included in the analytical algorithm are respectively satisfied, and
the analysis execution means outputs the question regarding a conditional branch other than the one or more conditional branches corresponding to the first information, among the conditional branches included in the analytical algorithm.

### (Supplementary Note 5)

The information processing device according to supplementary note 1, wherein
the prompt includes second information indicating a knowledge level of the user, and
the analysis execution means outputs the question using a phrase corresponding the knowledge level of the user.

### (Supplementary Note 6)

The information processing device according to supplementary note 1, wherein
the prompt includes a description designating the analytical algorithm, and
the algorithm acquisition means acquires the analytical algorithm included in the prompt.

### (Supplementary Note 7)

The information processing device according to supplementary note 1, wherein
the analytical algorithm is described in a programing language, and
the algorithm acquisition means interprets and executes the analytical algorithm using a language model capable of interpreting the programming language.
   (Supplementary note 8)

An information processing method performed by a computer, the information processing method comprising:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.

### (Supplementary Note 9)

A program causing a computer to perform a process comprising:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

This application is based upon and claims the benefit of priority from Japanese Patent Application 2023-209024, filed on Dec. 12, 2023, the disclosure of which is incorporated herein in its entirety by reference.

### DESCRIPTION OF SYMBOLS

10 Information processing device
111 Communication unit
112 Analysis unit
113 Analytical algorithm DB

1. An information processing device comprising:
at least one memory configured to store instructions; and
at least one processor configured to execute the instructions to:
acquire a prompt input by a user;
acquire an analytical algorithm designated in the prompt; and
output a question based on the analytical algorithm, execute the analytical algorithm interactively by acquiring an answer of the user to the question, and output an analysis result.

2. The information processing device according to claim 1, wherein
the analytical algorithm is described in natural language, and
the processor outputs the question using a language model, and also executes the analytical algorithm by interpreting the analytical algorithm using the language model.

3. The information processing device according to claim 1, wherein the processor outputs the question concerning each of conditional branches included in the analytical algorithm.

4. The information processing device according to claim 3, wherein
the prompt includes first information related to the one or more conditional branches, the first information indicating whether or not one or more conditions included in the analytical algorithm are respectively satisfied, and
the processor outputs the question regarding a conditional branch other than the one or more conditional branches corresponding to the first information, among the conditional branches included in the analytical algorithm.

5. The information processing device according to claim 1, wherein
the prompt includes second information indicating a knowledge level of the user, and
the processor outputs the question using a phrase corresponding the knowledge level of the user.

6. The information processing device according to claim 1, wherein
the prompt includes a description designating the analytical algorithm, and
the processor acquires the analytical algorithm included in the prompt.

7. The information processing device according to claim 1, wherein
the analytical algorithm is described in a programing language, and
the processor interprets and executes the analytical algorithm using a language model capable of interpreting the programming language.

8. An information processing method performed by a computer, the information processing method comprising:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.

9. A program causing a computer to perform a process comprising:
acquiring a prompt input by a user;
acquiring an analytical algorithm designated in the prompt; and
outputting a question based on the analytical algorithm, executing the analytical algorithm interactively by acquiring an answer of the user to the question, and outputting an analysis result.
